(19) United States
(12) Patent Application Publication
(10) Pub. No.: US 2012/0070745 A1
(43) Pub. Date: Mar. 22, 2012

(54) NEGATIVE ACTIVE MATERIAL FOR RECHARGEABLE LITHIUM BATTERY AND RECHARGEABLE LITHIUM BATTERY INCLUDING THE SAME

(75) Inventors: Sumihito ISHIDA, Yongin-si (KR); Jong-Ki Lee, Yongin-si (KR); Kyeu-Yoon Sheem, Yongin-si (KR); Mee-Young Lee, Yongin-si (KR)

(73) Assignee: Samsung SDI Co., Ltd., Yongin-si (KR)

(21) Appl. No.: 13/149,627

(22) Filed: May 31, 2011

Related U.S. Application Data
(60) Provisional application No. 61/383,701, filed on Sep. 16, 2010.

(51) Int. Cl. H01M 4/583; H01M 4/58

(52) U.S. Cl. 429/231.8; 429/218.1; 252/182.1

(57) ABSTRACT

Disclosed are a negative active material for a rechargeable lithium battery and a rechargeable lithium battery including the same. The active material includes a silicon-containing compound represented by the following Chemical Formula 1.

SiCₓ [Chemical Formula 1]
wherein, 0.05≦x≦1.5;
wherein the compound is substantially amorphous.

### CROSS-REFERENCE TO RELATED APPLICATIONS

This application claims priority to U.S. Provisional Application No. 61/383,701, filed on Sep. 16, 2010 which is incorporated herein in its entirety.

### BACKGROUND

1. Field

This disclosure relates to a negative active material for a rechargeable lithium battery, and a rechargeable lithium battery including the same.

2. Description of the Related Technology

Lithium rechargeable batteries have drawn attention as a power source for small portable electronic devices. Since they use an organic electrolyte solution, they have about twice as much discharge voltage than conventional batteries using an alkali aqueous solution, and accordingly have high energy density.

For positive active materials for a rechargeable lithium battery, a lithium-transition element composite oxide capable of intercalating lithium such as LiCoO₂, LiMn₂O₄, LiNi₁₋ₓCoₓ (0<x<1), and so on has been researched.

For a negative active material, various carbon-based material capable of intercalating/deintercalating lithium, such as artificial graphite, natural graphite, and hard carbon has been used.

In addition, as there is increasing requirements for a battery with high energy density, more attention has been paid to Si, Sn, and Ge alloyed with lithium, an oxide thereof, and an alloy thereof as a negative active material with high theoretical capacity density. In particular, the Si oxide has been widely researched regarding its good cycle characteristic. However, the Si oxide has a problem of having large irreversible capacity and deteriorating energy density of a battery to compensate Li, since oxygen therein reacts with Li and forms Li₂O (lithium oxide). In addition, the Li₂O is not participated in the charge and discharge but expands an electrode, deteriorating the energy density of a battery. Unless the Si oxide compensates the lithium, a battery may have not improved energy density. Furthermore, the Li₂O includes an alkali component and reacts with an electrolyte at a high temperature, and thus causes a problem of gas production, deteriorating capacity, and the like.

### SUMMARY

An example embodiment provides a negative active material for a rechargeable lithium battery having high density and excellent initial charge and discharge efficiency as well as cycle-life characteristic.

Another embodiment provides a rechargeable lithium battery including the negative active material.

According to one embodiment, a negative active material including a silicon-containing compound represented by the following Chemical Formula 1 is provided.

SiCx [Chemical Formula 1]

In Chemical Formula 1, 0.05≦x≦1.5. The x may be from about 0.25 to 0.95.

The silicon-containing compound may have a peak from 740 cm⁻¹ to 780 cm⁻¹ in Fourier transform infrared spectroscopy (FT-IR analysis).

The silicon-containing compound may be amorphous.

The silicon-containing compound may include a carbon layer on the surface thereof. Herein, the carbon layer may be included in an amount of 5 to 20 wt % based on the entire weight of the silicon-containing compound and the carbon layer.

The negative active material may further include an amorphous carbon-based material as well as the silicon-containing compound.

The silicon-containing compound and the amorphous carbon-based material are mixed in a ratio from 90:10 wt % to 10:90 wt %, or from 20:80 wt % to 60:40 wt % in an another embodiment.

When the silicon-containing compound and the amorphous carbon-based material are mixed together, the silicon-containing compound may have an average particle size from 0.1 μm to 30 μm.

The amorphous carbon-based material may have an interlayer spacing d002 from 0.34 nm to 0.4 nm in a 002 side and a crystallite size (Lc) from 2 nm to 5 nm in X-ray diffraction (XRD) measurement using CuKα.

According to an embodiment, provided is a rechargeable lithium battery including a negative electrode including the negative active material according to another embodiment, a positive electrode including a positive active material, and a non-aqueous electrolyte.

Therefore, a rechargeable lithium battery including the negative active material according to the embodiment has high energy density and excellent initial charge and discharge efficiency as well as cycle-life characteristic.

### BRIEF DESCRIPTION OF THE DRAWINGS

FIG. 1 schematically shows the structure of a rechargeable lithium battery according to one embodiment.

FIG. 2 is a graph showing initial charge and discharge characteristic and efficiency of a half-cell respectively including a negative electrode according to Examples 1 to 3 and Comparative Example 2.

FIG. 3 is a graph showing initial charge and discharge characteristic and efficiency of a half-cell respectively including a negative electrode according to Example 3 and Comparative Examples 1 and 4.

FIG. 4 is a graph showing X-ray diffraction (XRD) results of a material before it is formed into a carbon layer in Example 7 and Comparative Example 4.

FIG. 5 is a graph showing IR analysis results of a material before being formed into a carbon layer in Example 7 and Comparative Example 4.

FIG. 6 shows an electron probe micro-analyzer (EPMA) element analysis result of a SiCₓ (x=0.65) compound before being formed into a carbon layer in Example 7.

FIG. 7 shows the reversible capacity of the amorphous carbon particles used in Example 8.

### DETAILED DESCRIPTION

Example embodiments will hereinafter be described in detail. However, these embodiments are only examples, and the present embodiments are not limited thereto.

According to one embodiment, a negative active material for a rechargeable lithium battery may include a silicon-containing compound represented by the following Chemical Formula 1.

SiCₓ [Chemical Formula 1]

In Chemical Formula 1, 0.05≦x≦1.5. The x may be from about 0.25 to 0.95. When the x is smaller than 0.05, the particles may be easily broken due to a weak covalent bond, deteriorating the cycle-life characteristic at room temperature and at a high temperature. In addition, when the x is larger than 1.5, a silicon-containing compound may be relatively unstable and may have no lithium intercalation/deintercalation reaction, deteriorating capacity.

Since the silicon-containing compound does not include oxygen as shown in the above Chemical Formula 1, carbon in the silicon-containing compound does not react with Li to produce Li₂O, which may control expansion of an active material and prevent the side reaction of Li₂O, a strong alkali, with an electrolyte solution.

The silicon-containing compound includes a chemically covalent bond of silicon (Si) and carbon (C), but not a physical bond thereof. In addition, the silicon-containing compound has a peak from 740 cm⁻¹ to 780 cm⁻¹ in Fourier transform infrared spectroscopy (FT-IR) analysis, showing it has a covalent bond of silicon and carbon. The silicon-containing compound has no peak at 35° to 38° in the XRD measurement using CuKα, showing that it is amorphous.

If silicon and carbon have no chemically covalent bond but are physically mixed with each other as a simple mixture or a composite, it may have no peak in the FT-IR analysis and also no peak at 35° to 38° in the XRD measurement using CuKα. In addition, a silicon carbide with Si and C at an element ratio of 1:1, and with a diamond structure has a crystalline structure and thus a peak at 35 to 38° in the XRD measurement using CuKα.

In this way, a silicon-containing compound according to one embodiment includes a chemically covalent bond between silicon and carbon, and thus may prevent a particle from being broken.

The silicon-containing compound may be amorphous. When it is amorphous, the negative active material may improve cycle-life characteristic and particularly the high temperature cycle-life characteristic of a battery.

The silicon-containing compound may further include a carbon layer on the surface thereof. Herein, the carbon layer may be included in an amount of from about 5 wt % to about 20 wt % based on the entire amount of the silicon-containing compound and the carbon layer. When a silicon-containing compound includes a carbon layer on the surface thereof, and particularly a carbon layer within the above amount range, it may further improve electrical conductivity. It may further improve initial charge and discharge efficiency and the cycle-life characteristic of a battery, since the battery is better charged and discharged.

The carbon layer may comprise amorphous or crystalline carbon. A thickness of the carbon layer maybe suitably controlled, but is not limited.

The silicon-containing compound may be prepared in a sputtering process using Si and C targets. The sputtering process may be appropriately controlled to prepare a composition represented by the above Chemical Formula 1. However, a silicon-containing compound represented by the above Chemical Formula 1 may be prepared in any other method.

The negative active material may further include an amorphous carbon-based material as well as the silicon-containing compound. The amorphous carbon-based material may include soft carbon, hard carbon, mesophase pitch carbide, sintered cokes, or a combination thereof.

When a negative active material is prepared by mixing the silicon-containing compound with an amorphous carbon-based material, the amorphous carbon-based material may compensate the slow charge and discharge speed of the silicon-containing compound. Accordingly, it may make it possible to rapidly charge and discharge a battery and thus is useful for a high power battery.

Illustrated in more detail,when a rechargeable lithium battery including the negative active material prepared by mixing a silicon-containing compound and an amorphous carbon-based material is charged and discharged with a large current of 2 CmAh/cm² or more, lithium ions are inserted into the amorphous carbon-based material. With continuous charge, the lithium is diffused into a solid and then moves into a silicon-containing compound contacting the amorphous carbon-based material. This accounts for how a battery with high-capacity may be rapidly charged.

If crystalline carbon such as graphite is used instead of the amorphous material, lithium ions are inserted into a silicon-containing compound due to large resistance of the graphite, when charged and discharged with a large current of more than 2 CmAh/cm². However, the lithium is diffused at a lower speed inside a silicon-containing compound than a solid, resultantly generating a polarization voltage. Accordingly, a battery cannot be rapidly charged.

When a rechargeable lithium battery including a conventional graphite negative active material with a Li/Li⁺ potential of less than about 0.2V is charged with a large current, it cannot be rapidly charged in terms of safety, since the conventional graphite negative active material extracts Li. Recently, a rechargeable lithium battery has been rapidly charged even with a large current by enlarging an electrode area to decrease resistance without changing current per unit area. However, this method sharply decreases substantial energy density due to a volume increase of a current collector, a separator, and the like other than an active material.

In addition, this method has a problem of decreasing the charge speed of a lithium rechargeable battery, because an electrolyte solution may be easily decomposed on the edge of a crystal in a graphite negative active material where lithium is intercalated and deintercalated and produce a decomposed product, an SEI (solid electrolyte interface), on the surface, and lithium may not be diffused in the SEI. Recently, a silicon oxide having high-capacity and excellent cycle-life characteristic has also had a problem of reacting with lithium and thus producing Li₂O, a strong alkali, since the Li₂O decomposes an electrolyte solution as a strong alkali catalyst and thus produces a resistance component. In addition, the silicon oxide produces an SEI layer on the surface during the charge and discharge, increasing electrode resistance. Accordingly, it may not be good for a battery with high power. Furthermore, since a Si or Si alloy including no oxygen has no covalent bond inside the particle, it may be expanded and have a shape change when lithium is inserted therein, and then may be immediately broken on the interface of a crystal, deteriorating the cycle-life characteristic.

In addition, as for a mixed negative active material of a silicon-containing compound and an amorphous carbon-based material, lithium ions in the silicon-containing compound move toward the amorphous carbon-based material having excellent conductivity during the charge and may then be released during the rapid discharge.

Furthermore, an amorphous carbon-based material has better electrical conductivity than crystalline carbon such as graphite and can easily provide electrons required for Li oxidation since Li is released as ions, and it can be oxidized. Accordingly, the amorphous carbon material may bring about a better discharge characteristic than crystalline carbon such as graphite.

The silicon-containing compound and the amorphous carbon-based material are mixed in a ratio from about 90:10 wt % to about 10:90 wt %, or from about 20:80 wt % to about 60:40 wt % in another embodiment. When the silicon-containing compound is mixed with the amorphous carbon-based material within the ratio range, the negative active material may bring about high energy density as well as maintaining high input and output characteristics of a rechargeable lithium battery. Herein, the silicon-containing compound may have an average particle size from about 0.1 μm to about 30 μm.

The amorphous carbon-based material may have an interlayer spacing (d002) from 0.34 nm to 0.4 nm on a 002 side and crystallite size (Lc) from about 2 nm to about 5 nm in the XRD measurement using CuKα. When the amorphous carbon-based material has the property, lithium ions may be diffused faster and are more easily intercalated/deintercalated.

In addition, the amorphous carbon-based material has reversible capacity in a Li/Li⁺ potential region from about 0.2 to about 1.5V, and in particular, about 70% of the entire reversible capacity in the same potential region.

Another embodiment provides a rechargeable lithium battery.

Rechargeable lithium batteries may be classified as lithium ion batteries, lithium ion polymer batteries, and lithium polymer batteries according to the presence of a separator and the kind of an electrolyte used in a battery. Structures and fabricating methods for lithium ion batteries pertaining to this disclosure are well known in the art and are not illustrated in detail here.

According to another embodiment, a rechargeable lithium battery includes a negative electrode including a negative active material according to one embodiment, a positive electrode including a positive active material, and a non-aqueous electrolyte.

The negative electrode includes a negative active material layer and a current collector. Herein, the negative active material is sputtered into a thin film as a negative active material layer on a current collector, or is added to a solvent to prepare a negative active material composition as a slurry and then is disposed the negative active material composition is disposed on a current collector. The solvent may include N-methylpyrrolidone and the like. It may be water when a water-soluble binder is used for a negative electrode, but is not limited thereto.

The sputtering process may additionally need no binder to adhere a negative active material on a current collector.

However, the negative active material composition may further include a binder. The negative active material layer may include about 95 to about 99 wt % of the negative active material based on the total weight of the negative active material layer.

The negative active material layer may include about 1 to about 5 wt % of a binder based on the total weight of the negative active material layer.

The binder improves binding properties of the negative active material particles to one another and to a current collector.

The binder includes a non-water-soluble binder, a water-soluble binder, or a combination thereof.

The non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder includes, for example, a styrene-butadiene rubber, an acrylated styrene-butadiene rubber, polyvinyl alcohol, sodium polyacrylate, a copolymer including propylene and a C₂ to C₈ olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The cellulose-based compound includes one or more of carboxylmethyl cellulose, hydroxypropylmethyl cellulose, methyl cellulose, or alkaline metal salts thereof. The alkaline metal may be Na, K, or Li. The cellulose-based compound may be included in an amount of 0.1 to 3 parts by weight based on 100 parts by weight of the negative active material.

The negative active material composition may further include a solvent, and examples of the solvent include N-methylpyrrolidone and the like, but are not limited thereto.

The current collector includes a copper foil, a nickel foil, a stainless steel foil, a titanium foil, a nickel foam, a copper foam, a polymer substrate coated with a conductive metal, or combinations thereof.

The positive electrode includes a current collector and a positive active material layer disposed on the current collector. The positive active material includes lithiated intercalation compounds that reversibly intercalate and deintercalate lithium ions. The positive active material may include a composite oxide including at least one selected from the group consisting of cobalt, manganese, and nickel, as well as lithium. In particular, the following lithium-containing compounds may be used. LiₐA_{1-b}X_{b}D₂ (0.90≦a≦1.8, 0≦b≦0.5); LiₐE_{1-b}X_{b}O_{2-c}D_{c} (0.90≦a≦1.8, 0≦b≦0.5, 0≦c≦0.05); LiₐE_{2-b}X_{b}O_{4-c}D_{c} (0.90≦a≦1.8, 0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α<2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.9≦a≦1.8, 0.0001≦b≦0.1); QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃ (0≦f≦2); and LiFePO₄.

In the above formulas, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The compound may have a coating layer on the surface thereof, or may be mixed with another compound having a coating layer. The coating layer may include at least one coating element compound selected from the group consisting of an oxide of a coating element, a hydroxide of a coating element, an oxyhydroxide of a coating element, a carbon oxide of a coating element, and a hydroxyl carbonate of a coating element. The compound for a coating layer may be amorphous or crystalline. The coating element included in the coating layer may include, for example, Mg, Al, Co, K, Na, Ca, Si, Ti, V, Sn, Ge, Ga, B, As, Zr, or a mixture thereof. The coating layer may be formed in a method having no adverse influence on properties of a positive active material by including these elements in the compound. For example, the method may include any coating method such as spray coating, dipping, and the like, but is not illustrated in more detail, since it is well-known to those who work in the related field.

In the positive active material layer, the positive active material may be included in an amount of from about 90 to about 98 wt % based on the total weight of the positive active material layer.

The positive active material layer may further include a binder and a conductive material. The binder and the conductive material may be included in an amount of about 1 to about 5 wt %, based on the total weight of the positive active material layer, respectively.

The binder improves binding properties of positive active material particles to one another and to a current collector. Examples of the binder include at least one selected from polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material, unless it causes a chemical change. Examples of the conductive material include carbon-based materials such as natural graphite, artificial graphite, carbon black, acetylene black, ketjen black, carbon fiber, and the like; metal-based materials including a metal powder or a metal fiber of copper, nickel, aluminum, silver, and the like; a conductive polymer such as a polyphenylene derivative; or a mixture thereof.

The current collector may be Al foil but is not limited thereto.

The positive electrode may be fabricated in a method including mixing an active material, a conductive material, and a binder in a solvent to prepare an active material composition, and coating the composition on a current collector. The electrode manufacturing method is well known and is thus not described in detail in the present specification. The solvent includes N-methylpyrrolidone and the like, but is not limited thereto.

The non-aqueous electrolyte includes a non-aqueous organic solvent and a lithium salt.

The non-aqueous organic solvent serves as a medium of transmitting ions taking part in the electrochemical reaction of the battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like, and examples of the aprotic solvent include nitriles such as R—CN (where R is a C₂ to C₂₀ linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio can be controlled in accordance with a desirable battery performance.

The carbonate-based solvent may include a mixture with a cyclic carbonate and a linear carbonate. The cyclic carbonate and the chain carbonate are mixed together in a volume ratio of about 1:1 to about 1:9. When the mixture is used as an electrolyte, it may have enhanced performance.

In addition, the non-aqueous organic electrolyte may further include an aromatic hydrocarbon-based solvent as well as the carbonate-based solvent. The carbonate-based solvents and the aromatic hydrocarbon-based solvents may be mixed together in a volume ratio of about 1:1 to about 30:1.

The aromatic hydrocarbon-based organic solvent may be represented by the following Chemical Formula 2.

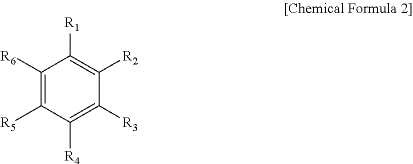

In the above Chemical Formula 2, R₁ to R₆ are independently hydrogen, a halogen, a C1 to C10 alkyl, a C1 to C10 haloalkyl, or a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include vinylene carbonate or an ethylene carbonate-based compound represented by the following Chemical Formula 3.

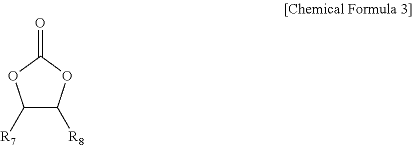

In the above Chemical Formula 3, R₇ and R₈ are independently hydrogen, a halogen, a cyano (CN), a nitro (NO₂), or a C1 to C5 fluoroalkyl, provided that at least one of R₇ and R₈ is a halogen, a nitro (NO₂), or a C1 to C5 fluoroalkyl, and R₇ and R₈ are not simultaneously hydrogen.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the additive for improving cycle life may be flexibly used within an appropriate range.

The lithium salt is dissolved in an organic solvent, supplies a battery with lithium ions, basically operates the rechargeable lithium battery, and improves transportation of the lithium ions between positive and negative electrodes. Non-limiting examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI and LiB(C₂O₄)₂ (lithium bis(oxalato) borate; LiBOB). The lithium salt may be used in a concentration from about 0.1 M to about 2.0 M. When the lithium salt is included at the above concentration range, an electrolyte may have optimal electrolyte conductivity and viscosity, and may thus have enhanced performance and effective lithium ion mobility.

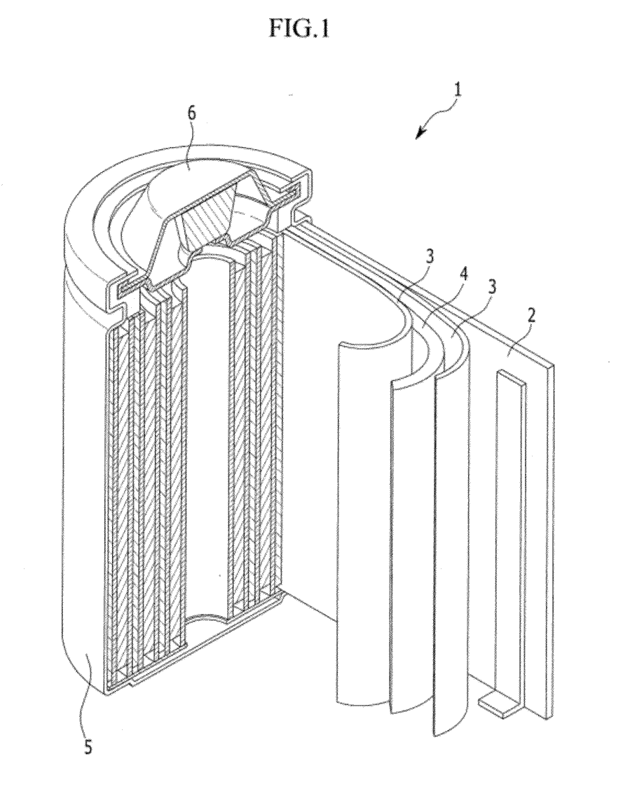

FIG. 1 is a schematic view showing the representative structure of a rechargeable lithium battery according to one embodiment. As shown in FIG. 1, a prismatic rechargeable lithium battery 1 includes a positive electrode 2, a negative electrode 4, and a separator 3 interposed between the negative electrode 2 and positive electrode 3 in a battery case 5, an electrolyte impregnating the separator 4, and a sealing member 6 sealing the battery case 5.

The rechargeable lithium battery may further include a separator between the negative electrode and the positive electrode, as needed. Non-limiting examples of a suitable separator material include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate this disclosure in more detail. These examples, however, are not in any sense to be interpreted as limiting the scope of this disclosure.

### Example 1

A SiCₓ (x=0.65) material was formed into a layer on a 20 μm-thick Cu film using a 2-source sputtering device and Si and C targets. The resulting product was used as a negative electrode, in which a negative active material layer including the SiCₓ (x=0.65) negative active material was disposed on a Cu current collector. Herein, the negative active material layer was 2 μm thick.

### Example 2

A SiCₓ (x=0.25) material was disposed into a layer on a 20 μm-thick Cu film, using a 2-source sputtering device and Si and C targets. The resulting product was used as a negative electrode, in which a negative active material layer including the SiCₓ (x=0.25) negative active material was disposed on a Cu current collector. Herein, the negative active material layer was 2 μm thick.

### Example 3

A SiCₓ (x=0.95) material was disposed into a layer on a 20 μm-thick Cu film, using a 2-source sputtering device and Si and C targets. The resulting product was used as a negative electrode, in which a negative active material layer including the SiCₓ (x=0.95) negative active material was disposed on a Cu current collector. Herein, the negative active material layer was 2 μm thick.

### Example 4

An SiCₓ (x=0.65) material was disposed to be 500 μm thick on a 5 μm-thick stainless steel (SUS) plate, using a 2-source sputtering device and Si and C targets. The SiCₓ (x=0.65) material layer was peeled off from the stainless steel plate. This peeled material was ground into powder with a size of about 10 μm, preparing a negative active material. 87 wt % of the negative active material was mixed with 10 wt % of a polyimide binder and 3 wt % of acetylene black in an N-methylpyrrolidone solvent. The mixture was coated on a Cu film and dried and compressed in a common method, fabricating a negative electrode.

### Example 5

A SiCₓ (x=0.05) material was disposed into a layer on a 20 μm-thick Cu film using a 2-source sputtering device and Si and C targets. The resulting product was used as a negative electrode, in which a negative active material layer including the SiCₓ (x=0.05) negative active material was disposed on a Cu current collector. Herein, the negative active material layer was 2 μm thick.

### Example 6

A SiCₓ (x=1.5) material was disposed into a layer on a 20 μm-thick Cu film using a 2-source sputtering device and Si and C targets. The resulting product was used as a negative electrode, in which a negative active material layer including the SiCₓ (x=1.5) negative active material was disposed on a Cu current collector. Herein, the negative active material layer was 2 μm thick.

### Example 7

An SiCₓ (x=0.65) material was disposed into a 500 μm-thick layer on a 5 mm-thick stainless steel (SUS) plate using a 2-source sputtering device and Si and C targets. The SiCₓ (x=0.65) material layer was peeled off from the stainless steel plate. The peeled layer was ground into powder with a size of about 10 μm.

The acquired SiCₓ (x=0.65) material was positioned on a glass board, and the glass board was positioned in the center of a tube furnace. The tube furnace was filled with argon gas to prevent air from entering the tube.

Next, the tube furnace was heated to 500° C. and then filled with a gas mixture of toluene and argon gas mixed in a volume % of 50:50 for 30 minutes and with argon gas again. The tube furnace was cooled to room temperature and then allowed to stand at the same room temperature, preparing a negative active material including a SiCₓ (x=0.65) material and an amorphous carbon layer with conductivity thereon. Herein, the carbon layer was included in an amount of 5 wt % based on the entire weight of the SiCₓ (x=0.65) material including the carbon layer thereon.

The negative active material was used to fabricate a negative electrode according to the same method as Example 4.

### Comparative Example 1

A SiOₓ (x=1.0) material was disposed to be 20 μm thick on a Cu film by radiating an energy beam on Si and SiO₂ targets in a thermal deposition device. The prepared product was used as a negative electrode, in which a negative active material layer including the SiOₓ (x=1.0) negative active material was disposed on a Cu current collector. Herein, the negative active material layer was 2 μm thick.

### Comparative Example 2

A negative electrode was fabricated according to the same method as Example 1, except for forming a SiCₓ (x=1.6) material layer on a 20 μm-thick Cu film by using a 2-source sputtering device and Si and C targets.

### Comparative Example 3

A negative electrode was fabricated according to the same method as Example 1, except for forming a SiCₓ (x=0.02) material layer on a 20 μm-thick Cu film by using a 2-source sputtering device and Si and C targets.

### Comparative Example 4

A negative electrode was fabricated according to the same method as Example 1, except for forming a 500 μm-thick SiCₓ (x=0.65) material layer on a 5 mm-thick stainless steel (SUS) plate by using a 2-source sputtering device and Si and C targets. The SiCₓ (x=0.65) material was peeled off from the stainless steel plate and then ground into powder with a size of about 10 μm.

The prepared SiCₓ (x=0.65) material was heated at 1200° C. under an argon atmosphere. During the heating process, crystalline SiCₓ (x=0.65) and Si that do not react with lithium were prepared.

The SiCₓ (x=0.65) and Si materials were positioned on a glass board. The glass board was positioned in the center of a tube furnace and then filled with argon gas to prevent air from entering the tube.

Next, the tube furnace was heated to 500° C. and then filled with a gas mixture of toluene and argon gas mixed in a volume % of 50:50 for 30 minutes, and then with argon gas again. The tube furnace was cooled to room temperature and allowed to stand at the same temperature, preparing a negative active material including a SiCₓ (x=0.65) and Si material and an amorphous carbon layer with conductivity thereon. Herein, the carbon layer was included in an amount of 5 wt % based on the entire weight of the SiCₓ (x=0.65) and Si materials having the carbon layer.

The negative active material was used to fabricate a negative electrode according to the same method as Example 4.

### Comparative Example 5

Si and graphite powders were mixed in a ratio of 35 wt %:65 wt %. The mixture was used as a negative active material.

87 wt % of the negative active material was mixed with 10 wt % of a polyimide binder and 3 wt % of acetylene black in an N-methylpyrrolidone solvent. The mixture was coated on a Cu film and then dried and compressed, fabricating a negative electrode in a common method.

### Fabrication of a Half-Cell

The negative electrodes according to Examples 1 to 7 and Comparative Examples 1 to 5 were used with a lithium metal counter electrode to fabricate a half-cell. The half-cells were measured regarding reversible capacity and initial efficiency. The results are provided in the following Table 1. The initial efficiency was calculated as initial discharge capacity/initial charge capacity by measuring their initial charge capacities, when the cells were charged with 0.05 C up to 0V (vs. Li/Li⁺) at 25° C., and their initial discharge capacities, when discharged with 0.05 C up to 1.5V (vs. Li/Li⁺).

### Fabrication of a Rechargeable Lithium Battery

95 wt % of a LiCoO₂ positive active material, 3 wt % of polyvinylidene fluoride, and 2 wt % of acetylene black were mixed in an N-methylpyrrolidone solvent, preparing a positive active material slurry. The slurry was coated on an Al film, fabricating a positive electrode.

The positive electrode and each negative electrode according to Examples 1 to 7 and Comparative Examples 1 to 5 were used together, fabricating a rechargeable lithium battery. Herein, an electrolyte solution was prepared by dissolving 1.0M LiPF₆ in a solvent of ethylene carbonate and diethylene carbonate mixed in a volume ratio of 1:1.

The rechargeable lithium battery was repeatedly charged and discharged 300 times at 0.2 C to 4.2V at 45° C. and discharged at 1.0 C to 3V.

The rechargeable lithium battery was evaluated regarding cycle-life characteristic by calculating a percentage of discharge capacity after being charged and discharged once against discharge capacity after being charged and discharged 300 times. The results are provided in the following Table 1.

TABLE 1

| | Negative active | | Capacity | Efficiency | 300^{th} cycle-life |
|---|---|---|---|---|---|
| | material | Property | (mAh/g) | (%) | (%, 45° C.) |
| Example 1 | SiCₓ (x = 0.65) | amorphous | 2520 | 93 | 82 |
| Example 2 | SiCₓ (x = 0.25) | amorphous | 3020 | 95 | 75 |
| Example 3 | SiCₓ (x = 0.95) | amorphous | 1800 | 91 | 87 |
| Example 4 | SiCₓ (x = 0.65) | amorphous | 2415 | 90 | 76 |
| Example 5 | SiCₓ (x = 0.05) | amorphous | 3670 | 97 | 71 |
| Example 6 | SiCₓ (x = 1.5) | amorphous | 820 | 77 | 83 |
| Example 7 | SiCₓ (x = 0.65) + carbon | amorphous | 2230 | 93 | 81 |
| | coating layer | | | | |
| Comparative | SiOₓ (x = 1.0) | amorphous | 1450 | 65 | 25 |
| Example 1 | | | | | |
| Comparative | SiCₓ (x = 1.6) | amorphous | 230 | 51 | 80 |
| Example 2 | | | | | |
| Comparative | SiCₓ (x = 0.02) | amorphous | 3350 | 98 | 5 |
| Example 3 | | | | | |
| Comparative | SiCₓ (x = 0.65) + carbon | crystalline | 250 | 80 | 23 |
| Example 4 | coating layer | | | | |
| Comparative | Si powder + carbon | crystalline | 1500 | 63 | 32 |
| Example 5 | powder 65% | | | | |

As shown in Table 1, rechargeable lithium batteries including the negative active materials according to Examples 1 to 7 had excellent capacity, efficiency, and cycle-life characteristics. On the contrary, rechargeable lithium batteries including the negative active materials according to Comparative Examples 1, 3, and 4 had a deteriorated cycle-life characteristic. In particular, the one of Comparative Example 3 had a sharply deteriorated cycle-life characteristic. In addition, the one of Comparative Example 2 had a little appropriate cycle-life but very low capacity. In addition, the ones of Comparative Examples 4 and 5 had bad cycle-life characteristics.

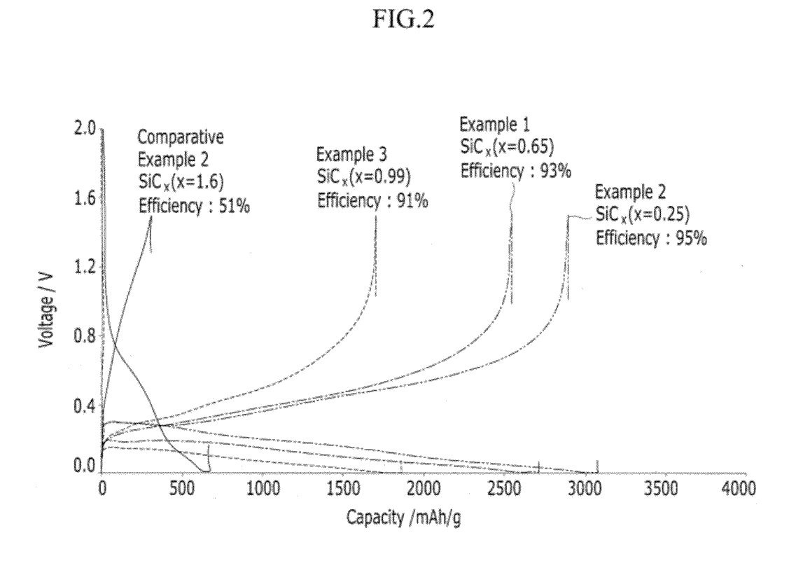

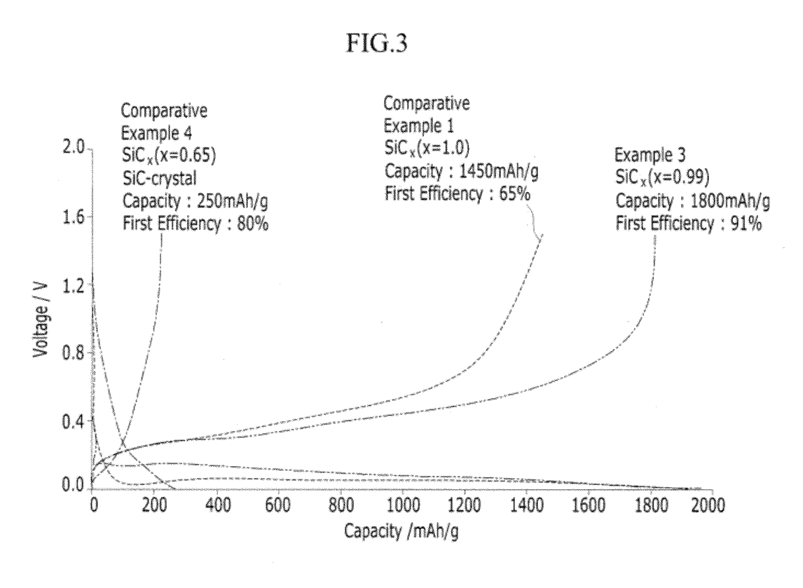

Furthermore, FIG. 2 provides initial charge and discharge characteristics and efficiency of the ones according to Examples 1 to 3 and Comparative Example 2. FIG. 3 shows charge and discharge characteristics and efficiency of the ones according to Example 3 and Comparative Examples 1 and 4.

As shown in FIG. 2, the heterogeneous phenomenon occurred in the one having an x value of more than 1.5 according to Comparative Example 2, and crystalline SiC crystals which had more stable and does not react lithium, were readily generated thereon and thus had extremely increased resistance. Accordingly, it had deteriorated capacity and 51% deteriorated charge and discharge efficiency. The ones according to Examples 1 to 3 respectively had very high initial charge and discharge efficiencies, at 93%, 95%, and 91%.

As shown in FIG. 3, the one including a SiO, (x=1.0) negative active material according to Comparative Example 1 had small discharge capacity against initial charge due to reaction of lithium with oxygen, and resultantly had a 65% decreased initial efficiency. In addition, the one of Comparative Example 4 had about initial efficiency of 80%. However, the one of Example 3 had high capacity very high charge and discharge efficiency and of 91%.

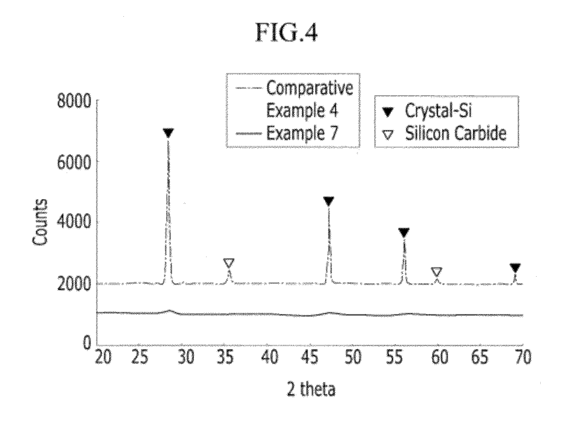

In addition, materials before the coating in Example 7 and Comparative Example 4 were measured regarding X-ray diffraction using CuKα. The result is provided in FIG. 4. As shown in FIG. 4, a SiCx (x=0.65) material prepared according to Example 4 had no peak at 2θ=35° to 38° and turned out to be amorphous. On the contrary, a carbon material of Example 4 had no peak at 2θ=35° to 38° in the X-ray diffraction.

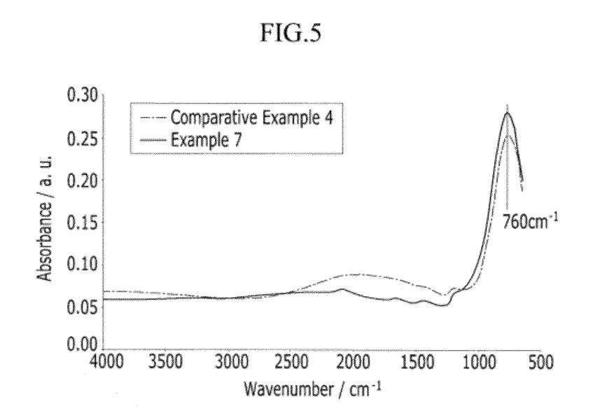

In addition, materials before being formed into a carbon layer in Example 7 and Comparative Example 4 were measured regarding IR. The results are provided in FIG. 5. As shown in FIG. 5, carbon materials before being formed into a layer in Example 7 and Comparative Example 4 had a peak around 760 cm⁻¹, showing that they had a Si—C covalent bond.

Based on the results in FIGS. 4 and 5, a material prepared according to Example 7 included Si and C uniformly dispersed therein, and had an amorphous structure. The material of Comparative Example 4 included silicon and silicon carbide completely separated and non-uniformly dispersed in the particle. In addition, as shown in FIG. 5, a material prepared according to Comparative Example 4 had a peak of 760 cm⁻¹, which shows silicon carbide.

As shown in FIGS. 4 and 5, when a material has a non-uniform structure inside the particle, it has a deteriorated cycle-life characteristic of a lithium rechargeable battery.

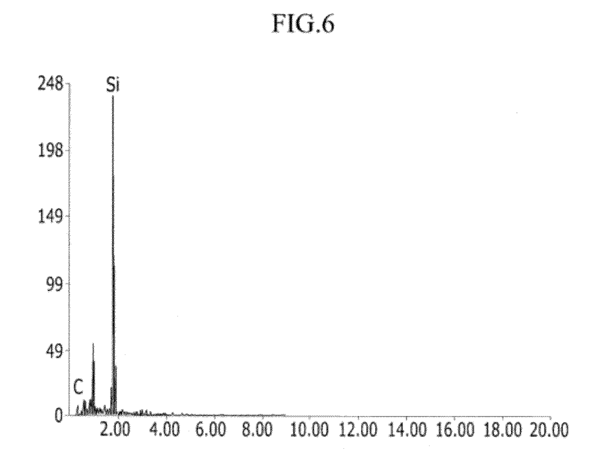

In addition, FIG. 6 shows the EPMA (electron probe micro-analyzer) element analysis result of a SiCₓ (x=0.65) material before being formed into a carbon layer in Example 7. As shown in FIG. 6, the prepared SiCₓ (x=0.65) compound included Si and C elements.

### Example 8

A SiCₓ (x=0.65) material was disposed into a 500 μm-thick layer on a stainless steel plate using a 2-source sputtering device and Si and C targets. The SiCₓ (x=0.65) material was peeled off from the stainless steel plate and then ground into powder with a size of about 10 μm, preparing an amorphous SiCₓ (x=0.65) material.

Amorphous carbon particles were prepared by blowing air into a petroleum-based pitch, subjecting it to infusible treatment at 400° C. for 2 hours, heat-treating the infusible product at 1200° C. under an argon atmosphere, and grinding it into a powder with a size of about 10 μm. When the resulting product was measured regarding XRD by using CuKα, it had an interlayer spacing d002 of about 0.35 nm and Lc of about 5 nm on a 002 side.

The amorphous SiCₓ (x=0.65) material was mixed with amorphous carbon particles in a weight ratio of about 50:50, preparing a negative active material. 87 wt % of the negative active material was mixed with 10 wt % of a polyimide binder and 3 wt % of acetylene black in an N-methylpyrrolidone solvent. The mixture was coated on a Cu film and dried and compressed in a common method, fabricating a negative electrode.

On the other hand, a positive electrode was fabricated by mixing about 95 wt % of a LiCoO₂ positive active material, about 3 wt % of polyvinylidene fluoride, and about 2 wt % of acetylene black in an N-methylpyrrolidone solvent to prepare positive active material slurry and coating the slurry on an Al film.

The negative and positive electrodes were used to fabricate a rechargeable lithium battery. Herein, an electrolyte solution was prepared by dissolving 1.0M LiPF₆ in a solvent of ethylene carbonate and diethylene carbonate mixed in a volume ratio of about 1:1.

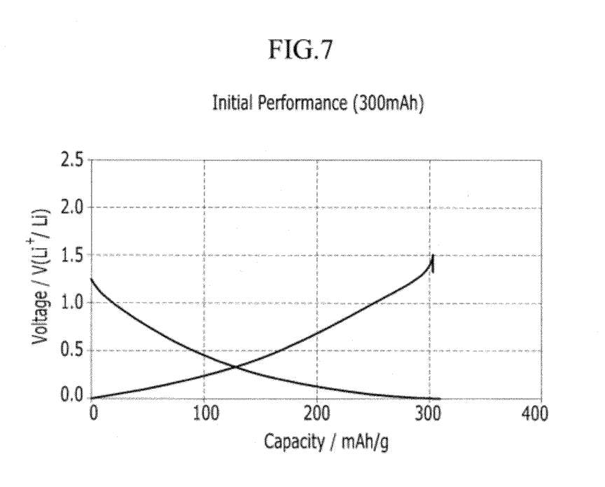

The reversible capacity of the amorphous carbon particles was measured by the following procedure. The amorphous carbon particles, a polyvinylidene fluoride binder and an acetylene black conductive material was mixed in an N-methyl pyrrolidone solvent at a weight ratio of 95:3:2, to prepare a slurry. The slurry was coated on a Cu foil to produce a negative electrode. Using the negative electrode and a lithium metal counter electrode, a coin cell was fabricated. The coin cell was charged at 0.2 C constant current to 0V (Li⁺/Li) and discharged at 0.2 C constant current to 1.5V (Li⁺/Li). The measured reversible capacity was shown in FIG. 7. As shown in FIG. 7, the amorphous carbon particle had reversible capacity in a Li⁺/Li potential region ranging from 0.2 to 1.5V, and 70% of the entire reversible capacity in the same potential range.

### Example 9

A rechargeable lithium battery was fabricated according to the same method as Example 8, except for preparing a negative active material by grinding an amorphous SiCₓ (x=0.25) material prepared by disposing a SiCₓ (x=0.25) material on a stainless steel plate using a 2-source sputtering device and Si and C targets according to the same method as Example 8, and mixing the ground product with the amorphous carbon particles of Example 8 in a weight ratio of about 50:50.

### Example 10

A rechargeable lithium battery was fabricated according to the same method as Example 8, except for preparing a negative active material by grinding an amorphous SiCₓ (x=0.95) material prepared by disposing a SiCₓ (x=0.95) material on a stainless steel plate using a 2-source sputtering device and Si and C targets according to the same method as Example 8, and mixing the ground product with the amorphous carbon particles of Example 8 in a weight ratio of 50:50.

### Example 11

The SiCₓ (x=0.65) material prepared according to Example 1 was ground and positioned on a glass board, and the glass board was positioned in the center of a tube furnace. The tube furnace was filled with argon gas to prevent air from entering the tube.

Next, the tube furnace was heated to about 500° C. and filled with a gas mixture of toluene and argon gas mixed in a volume % of about 50:50 for about 30 minutes, and then with argon gas again. The tube furnace was cooled to room temperature and allowed to stand at the same temperature, preparing a negative active material including a SiCₓ (x=0.65) material coated with conductive carbon on the surface thereof. Herein, the conductive carbon and the Sic, (x=0.65) material were mixed in a ratio of about 5:95 wt %.

A rechargeable lithium battery was fabricated according to the same method as Example 8, except for preparing a negative active material by mixing the resultant Deleted Texts with Deleted Texts the amorphous carbon particles of Example 8 in a weight ratio of 50:50.

### Comparative Example 6

A SiOₓ (x=1.0) material was thermally deposited to be 500 μm thick on a stainless plate by radiating an energy beam on Si and SiO₂ targets in a thermal deposition device.

Next, the deposited SiOₓ (x=1.0) was peeled off from the stainless plate and ground into SiOₓ (x=1.0) powder with a size of about 10 μm.

Then, a rechargeable lithium battery was fabricated except for preparing a negative active material by mixing the SiOₓ (x=1.0) powder with the amorphous carbon particles of Example 8 in a weight ratio of about 50:50.

### Comparative Example 7

A rechargeable lithium battery was fabricated according to the same method as Example 8, except for preparing a negative active material by grinding an amorphous SiCₓ (x=1.6) material prepared by being disposed on a stainless steel plate using a 2-source sputtering device and Si and C targets, and mixing the ground product with the amorphous carbon particles of Example 8 in a weight ratio of about 50:50.

### Comparative Example 8

A rechargeable lithium battery was fabricated according to the same method as Example 8, except for preparing a negative active material by grinding an amorphous SiC, (x=0.02) material prepared by being disposed on a stainless steel plate using a 2-source sputtering device and Si and C targets, and mixing the ground product with the amorphous carbon particles of Example 8 in a weight ratio of 50:50.

### Comparative Example 9

The SiCₓ (x=0.65) material was peeled off from a stainless steel plate and ground into powder with a size of about 10 μm according to Example 8. The SiCₓ (x=0.65) powder was heated at about 1200° C. under an argon atmosphere, acquiring crystalline SiCₓ (x=0.65) and Si that do not react with lithium.

Then, a rechargeable lithium battery was fabricated according to the same method as Example 8, except for preparing a negative active material by mixing the SiCₓ (x=65) material with the amorphous carbon of Example 8 in a ratio of about 50:50 wt %.

### Comparative Example 10

A rechargeable lithium battery was fabricated according to the same method as Example 8, except for using graphite powder with an average particle diameter of about 10 μm instead of amorphous carbon.

The rechargeable lithium batteries according to Examples 8 to 11 and Comparative Examples 6 to 10 were evaluated regarding charge efficiency (rapid charge and discharge) by comparing their capacities when charged at 30 C to 4.2V with the capacities when charged at 0.2 C to 4.2V as 100%. The results are provided in the following Table 2. In addition, their discharge efficiencies (rapid charge and discharge) were calculated by comparing the discharge capacities when discharged at 0.2 C to 2.5V from their charge status at 0.2 C to 4.2V with the discharge capacities at 30 C to 2.5V as 100%. The results are provided in the following Table 2.

Furthermore, the rechargeable lithium batteries according to Examples 8 to 11 and Comparative Examples 6 to 10 were evaluated regarding cycle-life characteristics by calculating a percentage of the discharge capacities at the 300^{th} charge and discharge against the 1^{st} discharge capacities after being charged 300 times at 4 C at a constant current charge to 4.2V at 45° C., and discharged at 4.0 C at a constant current discharge to 3V. The results are provided in the following Table 2.

TABLE 2

| | Negative active | | | | | | |
|---|---|---|---|---|---|---|---|
| | material | | Silicon- | | Charge | Discharge | |
| | silicon | carbon- | containing | Ratio of A1 | efficiency | efficiency | 300th |
| | compound | based | compound | and A2 | (30 C/0/2 C, | (30 C/0.2 C, | cycle-life |
| | A1 | A2 | property | (weight ratio) | %) | %) | (%, 45° C.) |
| Example 8 | SiCₓ | amorphous | amorphous | 50:50 | 72 | 81 | 81 |
| | (x = 0.65) | carbon | | | | | |
| Example 9 | SiCₓ | amorphous | amorphous | 50:50 | 68 | 78 | 72 |
| | (x = 0.25) | carbon | | | | | |
| Example 10 | SiCₓ | amorphous | amorphous | 50:50 | 75 | 84 | 84 |
| | (x = 0.95) | carbon | | | | | |
| Example 11 | SiCₓ with a | amorphous | amorphous | 50:50 | 80 | 85 | 85 |
| | carbon | carbon | | | | | |
| | coating | | | | | | |
| | layer | | | | | | |
| | (x = 0.65) | | | | | | |
| Comparative | SiOₓ | amorphous | amorphous | 50:50 | 21 | 42 | 35 |
| Example 6 | (x = 1.0) | carbon | | | | | |
| Comparative | SiCₓ | amorphous | amorphous | 50:50 | 30 | 37 | 25 |
| Example 7 | (x = 1.6) | carbon | | | | | |
| Comparative | SiCₓ | amorphous | amorphous | 50:50 | 35 | 37 | 80 |
| Example 8 | (x = 0.02) | carbon | | | | | |
| Comparative | SiCₓ | crystalline | amorphous | 50:50 | 60 | 65 | 5 |
| Example 9 | (x = 0.65) | | | | | | |
| Comparative | SiCₓ | graphite | crystalline | 50:50 | 15 | 42 | 23 |
| Example 10 | (x = 0.65) | | | | | | |

As shown in Table 2, the rechargeable lithium batteries respectively including the negative active materials according to Examples 8 to 11 had better high input and output characteristics (charge efficiency and discharge efficiency) and cycle-life characteristics than the ones of Comparative Examples 6 to 10.

The one of Comparative Example 6 had bad a high input and output characteristic, because oxygen in the SiOₓ negative active material reacted with Li and thereby produced Li₂O, which is a strong alkali, and the Li₂O as a catalyst decomposed an electrolyte solution and formed a layer on the surface of a negative electrode, which works as a resistance component.

In addition, the heterogeneous phenomenon occurred in the one having an x value of more than 1.5 according to Comparative Example 7, and crystalline SiC crystals which had more stable and are an insulator against lithium, were readily generated thereon. Accordingly, it might have extremely high resistance and deteriorated high input and output characteristics.

In general, the smaller an x value is, the higher capacity a lithium rechargeable battery has. However, when C was not included like Comparative Example 8, the negative active material of Comparative Example 8 might have broken particles due to a weak covalent bond inside the particles when lithium was intercalated/deintercalated. Accordingly, a battery with high capacity may have a deteriorated cycle-life characteristic.

On the other hand, since a crystalline SiCₓ (x=0.65) in Comparative Example 9 included crystalline SiC fine-crystals, and, has a break on the interface of Si and C bulk sides during repeated charges when Si and C were non-uniform, it may deteriorate current collecting and thus the cycle-life characteristic.

Furthermore, in Comparative Example 9 including a mixture of a SiCₓ compound with graphite instead of amorphous carbon, due to large resistance of the graphite, Li may be slowly inserted into graphite. Thus, Li may favorably inserted to SiCₓ than to graphite, bringing about polarization (V=IR, V increases due to high resistance when a large current flows). The polarization may cause a battery to instantly reach a charge-ending voltage, rather than charging the battery. In addition, the negative active material of Comparative Example 9 may not be appropriate for high rate charge and discharge, since lithium included in graphite may not be well released into an electrolyte during the discharge.

While this disclosure has been described in connection with what is presently considered to be practical example embodiments, it is to be understood that the embodiments are not limited to the disclosed embodiments, but, on the contrary, is intended to cover various modifications and equivalent arrangements included within the spirit and scope of the appended claims.

What is claimed is:

1. A negative active material for a secondary lithium battery comprising a compound represented by the following Chemical Formula 1,
SiCₓ [Chemical Formula 1]
wherein, 0.05≦x≦1.5;
wherein the compound is substantially amorphous.

2. The negative active material of claim 1, wherein x is from about 0.25 to about 0.95.

3. The negative active material of claim 1, wherein the compound has a peak from about 740 cm⁻¹ to about 780 cm⁻¹ as measured by Fourier transform infrared spectroscopy (FT-IR).

4. The negative active material of claim 1, wherein the compound has no significant peak from about 35° to about 38° as measured by X-ray diffraction (XRD) using CuKα as a radiation source.

5. The negative active material of claim 1, wherein the negative active material further comprises a carbon layer on the surface of the negative active material.

6. The negative active material of claim 5, wherein the carbon layer is from about 5 wt % to about 20 wt % based on the entire weight of the negative active material and the carbon layer.

7. The negative active material of claim 1, further comprising an amorphous carbon-based material.

8. The negative active material of claim 1, further comprising an amorphous carbon-based material, and wherein the amorphous carbon-based material is mixed with the compound in a ratio of from about 10:90 wt % to about 90:10 wt %.

9. The negative active material of claim 8, wherein the compound is mixed with the amorphous carbon-based material in a ratio of from about 20:80 wt % to about 60:40 wt %.

10. The negative active material of claim 7, wherein the amorphous carbon-based material has interlayer spacing d002 of from about 0.34 nm to about 0.4 nm in a 002 plane when the XRD is measured using CuKα.

11. The negative active material of claim 7, wherein the amorphous carbon-based material has a crystal lattice (Lc) of from about 2 nm to about 5 nm when the XRD is measured using CuKα.

12. The negative active material of claim 7, wherein the amorphous carbon-based material has reversible capacity in a Li/Li+potential region ranging from 0.2 to 1.5V.

13. The negative active material of claim 7, wherein the amorphous carbon-based material has reversible capacity in a Li/Li⁺ potential region of from about 0.2 to about 1.5V, optionally wherein the amorphous carbon-based material has about 70% of the entire reversible capacity in said potential region.

14. A secondary lithium battery comprising:
a negative electrode comprising a negative active material comprising a compound represented by the following Chemical Formula 1;
a positive electrode comprising a positive active material; and
a non-aqueous electrolyte,
SiCₓ [Chemical Formula 1]
wherein, 0.05≦x≦1.5;
wherein the compound is substantially amorphous.

15. The secondary lithium battery of claim 14, wherein x is from about 0.25 to about 0.95.

16. The secondary lithium battery of claim 14, wherein the compound has a peak of from about 740 cm⁻¹ to about 780 cm⁻¹ as measured by FT-IR analysis.

17. The secondary lithium battery of claim 14, wherein the compound has no significant peak from about 35° to about 38° as measured by XRD spectroscopy using CuKα as a radiation source.

18. The secondary lithium battery of claim 14, wherein the negative active material further comprises an exterior carbon layer.

19. The secondary lithium battery of claim 18, wherein the exterior carbon layer is from about 5 wt % to about 20 wt % based on the entire weight of the negative active material and the exterior carbon layer.

20. The secondary lithium battery of claim 14, further comprising an amorphous carbon-based material.

21. The secondary lithium battery of claim 14, wherein the negative active material further comprises an amorphous carbon-based material, and wherein the amorphous carbon-based material is mixed with the compound in a ratio of from about 10:90 wt % to about 90:10 wt %.

22. The secondary lithium battery of claim 14, wherein the compound is mixed with the amorphous carbon-based material in a ratio of from about 20:80 wt % to about 60:40 wt %.

23. The secondary lithium battery of claim 20, wherein the amorphous carbon-based material has an interlayer spacing d002 of from about 0.34 nm to about 0.4 nm in a 002 plane in the XRD measurement using CuKα.

24. The secondary lithium battery of claim 20, wherein the amorphous carbon-based material has a crystal lattice (Lc) of from about 2 nm to about 5 nm in the XRD measurement using CuKα.
